(19) United States
(12) Patent Application Publication
(10) Pub. No.: US 2025/0104339 A1
(43) Pub. Date: Mar. 27, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventors: Ryosuke HIGASHIKATA, Kanagawa (JP); Tomonari TAKAHASHI, Kanagawa (JP); Atsushi OGIHARA, Kanagawa (JP); Yasuyuki TANAKA, Kanagawa (JP)

(73) Assignee: FUJIFILM Business Innovation Corp., Tokyo (JP)

(21) Appl. No.: 18/430,686

(22) Filed: Feb. 2, 2024

(30) Foreign Application Priority Data
Sep. 22, 2023 (JP) 2023-159211

(51) Int. Cl. G06T 17/00; G06T 7/60; G06V 10/74

(52) U.S. Cl. CPC G06T 17/00; G06T 7/60; G06V 10/761

(57) ABSTRACT

An information processing system includes a processor configured to perform a process including: obtaining a first measurement of a shaped article manufactured under a first condition for a three-dimensional model serving as a basis and a second measurement of the shaped article manufactured under a second condition for the three-dimensional model; and displaying an object representing a comparison result of comparing the first measurement and the second measurement at a corresponding position on the three-dimensional model of the shaped article.

### CROSS-REFERENCE TO RELATED APPLICATIONS

This application is based on and claims priority under 35 USC 119 from Japanese Patent Application No. 2023-159211 filed Sep. 22, 2023.

### BACKGROUND

### (i) Technical Field

The present disclosure relates to an information processing system and a non-transitory computer readable medium.

### (ii) Related Art

Japanese Patent Publication No. 6,735,367 proposes to prototype a product using a mold, measure the positions of multiple measurement points in the prototyped product, calculate the magnitude of misalignment between the measurements at the measurement points and design values, display the magnitude of misalignment on a drawing of the shape of the product, adjust the positions in the product coordinate system of the product so that the magnitude of misalignment at the measurement points is reduced, calculate the magnitude of misalignment relative to the design values in the product coordinate system after the adjustment, and correct the mold based on the calculated magnitude of misalignment.

In the case of checking the quality of a shaped article, it is cumbersome to compare a design drawing, various determination results entered in an inspection table, and a three-dimensional model to one another to grasp the finished state of the shaped article in the head. In particular, in the case of checking the quality of a shaped article manufactured under different conditions related to the finished state of the shaped article, because it is necessary to check the finished state of the shaped article under each condition, it is cumbersome to grasp the quality changes such as changes and variations in the shaped article in each condition or between conditions.

### SUMMARY

Aspects of non-limiting embodiments of the present disclosure relate to providing an information processing system and a non-transitory computer readable medium storing an information processing program capable of visualizing quality changes in a shaped article manufactured under different conditions related to the quality of the shaped article.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to perform a process including: obtaining a first measurement of a shaped article manufactured under a first condition for a three-dimensional model serving as a basis, and a second measurement of the shaped article manufactured under a second condition for the three-dimensional model; and displaying an object representing a comparison result of comparing the first measurement and the second measurement at a corresponding position on the three-dimensional model of the shaped article.

### BRIEF DESCRIPTION OF THE DRAWINGS

An exemplary embodiment of the present disclosure will be described in detail based on the following figures, wherein:

FIG. 1 is a diagram illustrating a schematic configuration example of an information processing system according to an exemplary embodiment;

FIG. 2 is a block diagram illustrating the key configuration of the electrical system of client terminals and a server in the information processing system according to the exemplary embodiment;

FIG. 3 is a functional block diagram illustrating a functional configuration of the information processing system according to the exemplary embodiment;

FIG. 4 is a diagram illustrating an example of a screen displaying an object;

FIG. 5 is a diagram illustrating an example of displaying objects representing comparison results of comparing the measurements of a shaped article manufactured under two conditions and a reference value while switching between the objects on a condition-by-condition basis;

FIG. 6 is a diagram illustrating an example of displaying an object representing a comparison result of comparing the measurements under the two conditions;

FIG. 7 is a diagram illustrating an example of displaying objects at multiple locations on a three-dimensional model;

FIG. 8 is a diagram illustrating a case representing the standards for individual dimensions;

FIG. 9 is a diagram illustrating a case representing that there are twelve holes with a diameter of Φ3 and three holes with a diameter of Φ6;

FIG. 10 is a diagram illustrating a case representing that there are three sets of the same dimension group (four holes with a diameter of Φ3 and one hole with a diameter of Φ6), providing an example description that there are three sets of dimension groups;

FIG. 11 is a diagram illustrating a case representing that there are three sets of the same dimension group (four holes with a diameter of Φ3 and one hole with a diameter of Φ6), providing another example description that there are three sets of dimension groups;

FIG. 12 is a diagram illustrating a case representing that there are three sets of the same dimension group (four holes with a diameter of Φ3 and one hole with a diameter of Φ6), providing yet another example description that there are three sets of dimension groups;

FIG. 13 is a flowchart illustrating an example of the flow of a first process performed by the information processing system according to the exemplary embodiment;

Fig, 14 is a flowchart illustrating an example of the flow of a second process performed by the information processing system according to the exemplary embodiment; and

FIG. 15 is a diagram illustrating a general-purpose personal computer.

### DETAILED DESCRIPTION

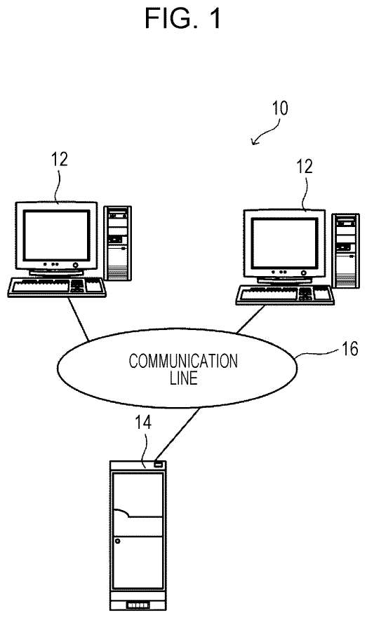

Hereinafter, an exemplary embodiment of the present disclosure will be described in detail with reference to the drawings. FIG. 1 is a diagram illustrating a schematic configuration example of an information processing system according to the exemplary embodiment.

An information processing system 10 according to the exemplary embodiment includes client terminals 12 and a server 14, as illustrated in FIG. 1. The client terminals 12 and the server 14 are each connected to a communication line 16 and are capable of communicating with each other via the communication line 16. As an example of the communication line 16, a network such as the Internet, a local area network (LAN), a wide area network (WAN), etc. is applied by way of example. Although FIG. 1 illustrates an example in which there are multiple (two in FIG. 1) client terminals 12, there may be a single client terminal 12 or three or more client terminals 12. Moreover, a personal computer or a mobile terminal such as a tablet terminal or a smartphone may be applied as each client terminal 12.

The information processing system 10 according to the exemplary embodiment obtains measurements by measuring to-be-inspected positions of a shaped article manufactured under different conditions related to the quality of the shaped article. Then, the information processing system 10 displays an object representing the results of comparing the measurements under the different conditions on a three-dimensional model, or separately displays objects representing the results of comparing the measurements and a predetermined reference value on a three-dimensional model while switching between the objects on a condition-by-condition basis, thereby supporting the evaluation of the product quality.

In the present disclosure, the term “different conditions” refers to factors related to the quality of the shaped article, with at least one factor having at least two levels or more. Examples of factors that can serve as conditions include the following: sample differences manufactured with the same mold and under the same conditions, lot differences such as different manufacturing dates, differences before and after mold modifications, differences before and after mold transfer between factories or machines, material differences by manufacturer, lot, and model number, differences in molding conditions such as temperature, pressure, and speed, and differences in molds such as the first mold, the second mold, or multiple cavities within the same mold. Also, the different conditions are not limited to these factors and may be other factors as long as they are conditions related to the quality of the shaped article.

In addition, the term “shaped article” refers to an article that has been processed into a certain shape, and is an object such as an industrial mass-produced part. For example, there are various types of shaping processes as follows: injection molding and casting, where materials are filled into a space enclosed by a mold to be solidified; press molding, where sheet-like materials are pressed to be deformed; machining using cutting machines; welding using arcs and/or lasers; and additive manufacturing using three-dimensional printers. As long as the formed object is concerned, it falls within the scope of application of the information processing system 10 according to the exemplary embodiment.

In addition, the term “three-dimensional model” represents a three-dimensional computer aided design (CAD) model, and the term “product manufacturing information (PMI)” refers to product manufacturing information necessary for manufacturing products, such as dimensions, tolerances, annotations, surface finishes, and materials associated with the three-dimensional model, which serve as reference values for the shaped article.

In addition, the term “to measure” refers to the act of obtaining values such as positions, lengths, angles, etc. of a to-be-inspected shaped article using a measuring machine.

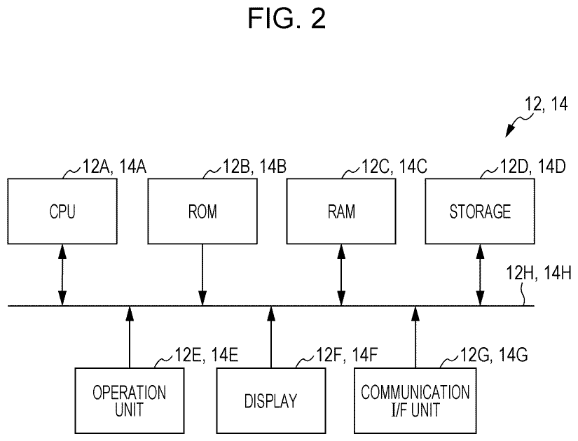

FIG. 2 is a block diagram illustrating the key configuration of the electrical system of the client terminals 12 and the server 14 in the information processing system 10 according to the exemplary embodiment. Because the client terminals 12 and the server 14 have general computer configurations, one client terminal 12 will be described below as a representative thereof.

The client terminal 12 includes a central processing unit (CPU) 12A as an example of a processor, a read-only memory (ROM) 12B, a random-access memory (RAM) 12C, a storage 12D, an operation unit 12E, a display 12F, and a communication interface (I/F) unit 12G. The CPU 12A is responsible for the overall operation of the client terminal 12. The ROM 12B stores various control programs, various parameters, and the like in advance. The RAM 12C is used as a work area, for example, for execution of various programs by the CPU 12A. The storage 12D stores various types of data, application programs, and the like. The operation unit 12E is used for inputting various types of information. The display 12F is used for displaying various types of information. The communication I/F unit 12G is connected to an external device and transmits and receives various types of data to and from the external device. These units of the client terminal 12 described above are electrically connected to each other by a system bus 12H. Although the client terminal 12 according to the exemplary embodiment applies the storage 12D as a storage unit, this is not the only possible case, and other non-volatile storage units such as hard disks and flash memory may be applied.

According to the above configuration, the client terminal 12 according to the exemplary embodiment performs, with the use of the CPU 12A, access to the ROM 12B, the RAM 12C, and the storage 12D, acquisition of various types of data via the operation unit 12E, and display of various types of information on the display 12F. In addition, the client terminal 12 performs, with the use of the CPU 12A, control of the transmission and reception of various types of data via the communication I/F unit 12G.

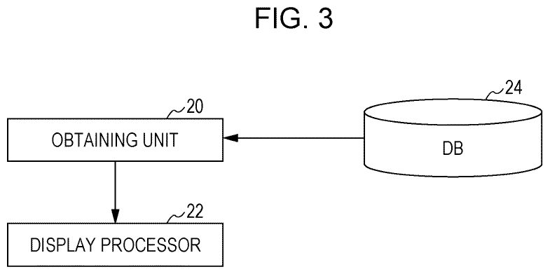

The information processing system 10 according to the exemplary embodiment realizes the functions illustrated in FIG. 3 by the CPU 12A of the client terminal 12 which expands an information processing program stored in advance in the ROM 12B into the RAM 12C and executes it. FIG. 3 is a functional block diagram illustrating the functional configuration of the information processing system 10 according to the exemplary embodiment.

The information processing system 10 according to the exemplary embodiment has the functions of an obtaining unit 20 and a display processor 22, as illustrated in FIG. 3. Although the functions of the obtaining unit 20 and the display processor 22 are described as functions of the client terminal 12 in the exemplary embodiment, they may be functions of the server 14.

The obtaining unit 20 obtains the measurements of a shaped article manufactured under different conditions related to the quality of the shaped article.

For example, a first measurement of a shaped article manufactured under a first condition for a three-dimensional model serving as a basis and a second measurement of the shaped article manufactured under a second condition different from the first condition for the three-dimensional model are stored in the server 14 as a database (DB) 24. The obtaining unit 20 then obtains the first measurement and the second measurement from the DB 24. The measurements obtained by the obtaining unit 20 include, for example, measurements obtained by a three-dimensional measuring machine that measures the three-dimensional coordinates of a to-be-inspected shaped article by bringing an inspection probe into direct contact with the shaped article, and measurements measured on the three-dimensional coordinates by a three-dimensional measuring machine that measures the three-dimensional coordinates contactlessly through acquisition of optical images, as well as measurements measured using analog techniques.

The display processor 22 performs a process of displaying an object representing a comparison result of comparing measurements under different conditions obtained by the obtaining unit 20 at a corresponding position on a three-dimensional model, or a process of displaying objects representing comparison results of comparing the measurements and a reference value at a corresponding position on the three-dimensional model while switching between the objects on a condition-by-condition basis. Here, “to display at a corresponding position on the three-dimensional model” refers to displaying a determination result, obtained by the determination from the measurement result, and a specified standard on the three-dimensional model using a three-dimensional object such as an arrow at the location which is the rough measurement position of the shaped article.

The display processor 22 performs, for example, a process of displaying an object representing a comparison result of comparing a first measurement of a shaped article manufactured under a first condition and a second measurement of the shaped article manufactured under a second condition at a corresponding position on the three-dimensional model of the shaped article. As an object representing a comparison result of comparing the first measurement and the second measurement, an object is displayed representing, for example, PMI that has improved or deteriorated based on the measurements under the two different conditions, and the direction and amount of the change. Also, an object representing a comparison result of comparing the first measurement and the second measurement may represent a comparison result of comparing the mean values or worst-case values of the first measurement and the second measurement. For example, as an example of a comparison method, the difference between the first measurement and the second measurement is calculated. The difference can be calculated more preferably using a better determination result relative to PMI as a reference because it allows checking of the deterioration direction and amount; however, it is also acceptable to calculate the difference using a deteriorated determination result relative to PMI as a reference. Alternatively, a reference for the difference may be set by a user. For example, when a user specifies the first measurement and the second measurement, it is acceptable to set the initially specified measurement as a reference for the difference.

The display processor 22 also performs, for example, a process of separately displaying a first object representing a comparison result of comparing the first measurement and a predetermined reference value and a second object representing a comparison result of comparing the second measurement and the predetermined reference value at a corresponding position on the three-dimensional model of the shaped article, and performs a process of displaying the first object and the second object while switching between them based on a preset condition. The first object and the second object each display, for example, an object representing a direction and an amount of deviation relative to PMI as an example of the predetermined reference value. Alternatively, the first object and the second object may each represent a comparison result of comparing the mean value or worst-case value of each measurement and the reference value, or may each represent a comparison result of comparing another value and the reference value.

Note that, hereinafter, a process of displaying an object representing a comparison result of comparing measurements under different conditions with each other at a corresponding position on the three-dimensional model may be referred to as a first process. In addition, a process of separately displaying objects each representing a comparison result of comparing a measurement and a reference value on the three-dimensional model while switching between the objects on a condition-by-condition basis may be referred to as a second process.

As an example of an object, an object with a shape such as a circle, triangle, square, etc., or an arrow object is displayed. In addition, the physical quantity such as the difference value or the amount of deviation from the reference value may be represented by changing the display mode such as color, size, length, etc. For example, in the case of displaying an arrow object, a direction of deviation from PMI as a reference value, a direction indicated by the difference value, etc., may be displayed, and at least one of a change amount such as a deviation amount and a determination result of the necessity for PMI may be displayed by changing the color.

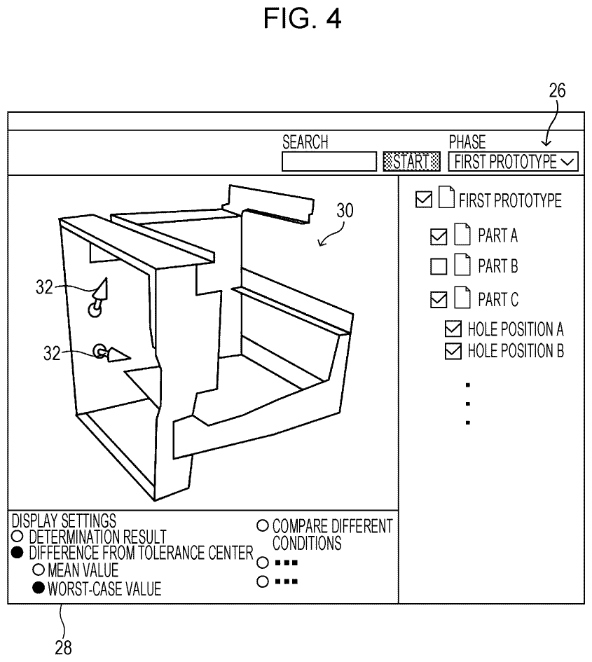

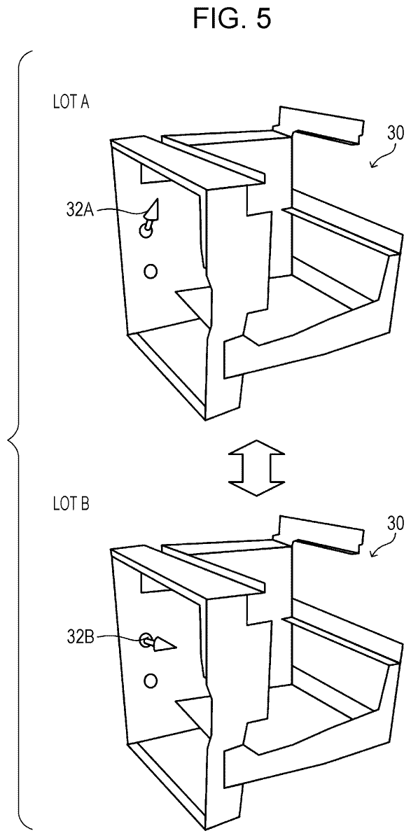

An example of a screen displaying the above-described object will now be described. FIG. 4 is a diagram illustrating an example of a screen displaying an object. Note that the screen example is merely an example and is not limited to the screen illustrated in FIG. 4.

The screen illustrated in FIG. 4 indicates an example in which an arrow object 32 is displayed at two hole positions on a three-dimensional model 30. Also, in the screen illustrated in FIG. 4, different conditions related to the quality of a shaped article are selected from a list box 26 for selecting a phase. In the example illustrated in FIG. 4, an example in which a first prototype is selected as a phase is illustrated. In the list box 26, for example, the following factors are preset as phases: sample differences manufactured with the same mold and under the same conditions; lot differences such as different manufacturing dates; differences before and after mold modifications; differences before and after mold transfer between factories or machines; material differences by manufacturer, lot, and model number; differences in molding conditions such as temperature, pressure, and speed; and differences in molds such as the first mold, the second mold, or multiple cavities within the same mold. These phases are then selectably listed. In addition, measured parts corresponding to the selected phase are displayed, and the parts to be displayed are selectable. In the example illustrated in FIG. 4, an example is indicated in which parts A, B, and C are displayed as the parts measured in the first prototype, and parts A and C are selected. Moreover, the inspection position is made selectable for each part, and, in the example illustrated in FIG. 4, an example is indicated in which the hole position A and the hole position B are selected.

In addition, the display settings of the first process and the second process may be made by a radio button in a display setting field 28 illustrated in FIG. 4. In the example illustrated in FIG. 4, the first process is performed by selecting the radio button “compare different conditions”, for example. In contrast, the second process is performed by selecting “determination result” or “difference from tolerance center”.

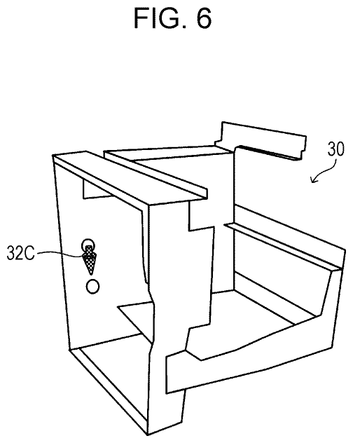

Here, an example of the second process of separately displaying the objects 32 each representing the result of comparing a measurement and a reference value on the three-dimensional model 30 while switching between the objects 32 on a condition-by-condition basis will be specifically described. FIG. 5 is a diagram illustrating an example of displaying the objects 32 representing comparison results of comparing measurements of a shaped article manufactured under two conditions and a reference value while switching between the objects 32 on a condition-by-condition basis. In the example illustrated in FIG. 5, an example is indicated in which the objects 32 are displayed on the three-dimensional model 30 while switching between lot A and lot B as an example of a condition.

FIG. 5 illustrates an example of displaying arrow-shaped objects each representing the result of comparing a measurement at a hole position in a shaped article and a reference value. FIG. 5 illustrates an example of separately displaying a first object 32A representing a comparison result of comparing a measurement in lot A and a reference value and a second object 32B representing a comparison result of comparing a measurement in lot B and the reference value on the three-dimensional model 30 while switching between the objects 32A and 32B. In the case of lot A, it is indicated that it is deviated from PMI in the arrow direction, and the amount of deviation is indicated by the color of the arrow. Note that the amount of deviation may be represented in terms of the length of the arrow, or may be represented in terms of a display mode such as color. In FIG. 5, it is indicated that, in lot A, the hole position is deviated from PMI in the upward direction of FIG. 5, and, in lot B, the hole position is deviated from PMI in the front direction on the paper surface in FIG. 5. The object 32A in lot A and the object 32B in lot B are displayed while switching between them through a user operation, for example. As a result, changes in the finished state of the shaped article due to differences in the conditions of lot A and lot B can be visualized.

Next, an example of the first process of displaying the object 32 representing a comparison result of comparing measurements under different conditions to each other at a corresponding position on the three-dimensional model 30 will be specifically described. FIG. 6 is a diagram illustrating an example of displaying a third object 32C representing a comparison result of comparing measurements under two conditions. In FIG. 6, an example of displaying the third object 32C representing a difference between measurements at a hole position under two conditions is illustrated by way of example. In the example illustrated in FIG. 6, an example is indicated in which the difference between measurements under two conditions is indicated by an arrow, illustrating that there is a difference in the downward direction of FIG. 6. Note that the magnitude of the difference may be represented in terms of the length of the arrow, or may be represented in terms of a display mode such as color. Also, the variation between the two conditions may be represented as “pass” or “fail” in terms of a display mode such as color.

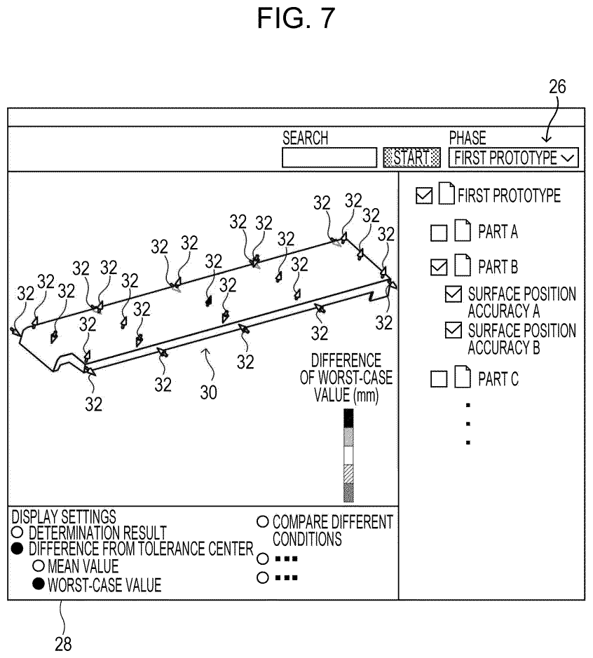

Note that, as for the objects 32, an example in which one object 32 is displayed at one inspection position is illustrated in FIGS. 4 to 6; however, one location is not the only possible case, and, for example, as illustrated in FIG. 7, multiple objects 32 may be displayed at multiple locations on the three-dimensional model 30. FIG. 7 illustrates, for the measurements at multiple locations for the surface position accuracy, an example is indicated in which each object 32 representing the difference of the worst-case value from the tolerance center is displayed as a comparison result of comparing the measurement and the reference value. In FIG. 7, an example in which the difference of the worst-case value is displayed in terms of a display mode such as the color of the object is illustrated.

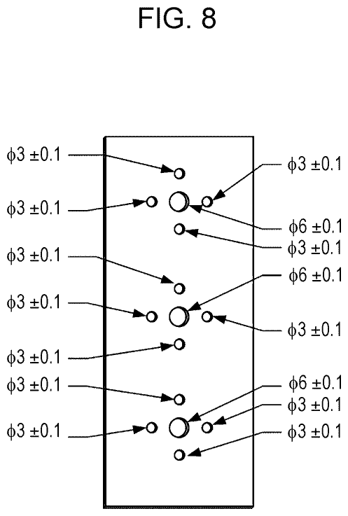

Also, in the case of displaying each object 32, information of PMI at the inspection position of the object 32 may also be displayed. As for a display method, display methods as illustrated in FIGS. 8 to 12 are available. Switching between display methods may be made selectable by a user. Alternatively, switching between display methods may be performed according to the display size of the three-dimensional model 30.

FIG. 8 is a diagram illustrating a case representing the standards for individual dimensions. FIG. 8 illustrates an example in which the diameter of the holes and their tolerances are displayed. In FIG. 8, an example is illustrated in which, when there are three holes with a diameter of Φ6±0.1 and four holes with a diameter of Φ3±0.1 around these three holes, the dimensions and tolerances of the holes are displayed.

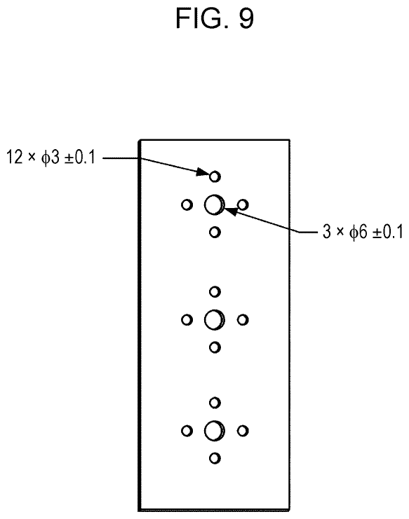

FIG. 9 is a diagram illustrating a case representing that there are twelve holes with a diameter of Φ3 and three holes with a diameter of Φ6. In FIG. 9, the display method is changed for the same parts as those in FIG. 8. In FIG. 9, 12×Φ3±0.1 indicates that there are twelve holes with a diameter of Φ3±0.1, and 3×Φ6±0.1 indicates that there are three holes with a diameter of Φ6±0.1.

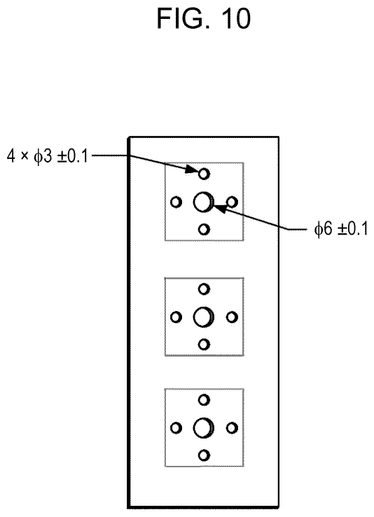

FIG. 10 is a diagram illustrating a case representing that there are three sets of the same dimension group (four holes with a diameter of Φ3 and one hole with a diameter of Φ6), providing an example description that there are three sets of dimension groups. In FIG. 10, for the same parts as those illustrated in FIG. 8, each set of dimension groups is enclosed by a square frame; 4×Φ3±0.1 indicates that there are four holes with a diameter of Φ3±0.1 in each set of dimension groups; and Φ6±0.1 indicates that there is one hole with a diameter of Φ6±0.1 in each set of dimension groups.

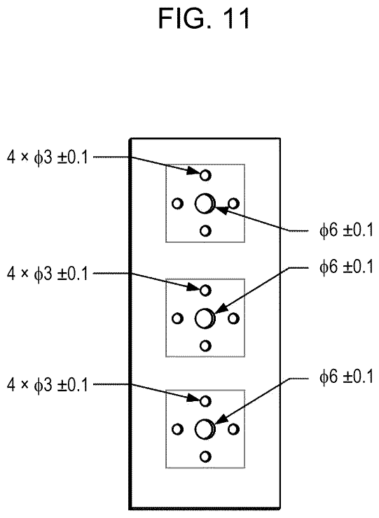

FIG. 11 is a diagram illustrating a case representing that there are three sets of the same dimension group (four holes with a diameter of Φ3 and one hole with a diameter of Φ6), illustrating another example description that there are three sets of dimension groups. In FIG. 11, an example in which the description illustrated in FIG. 10 is described for each set is illustrated.

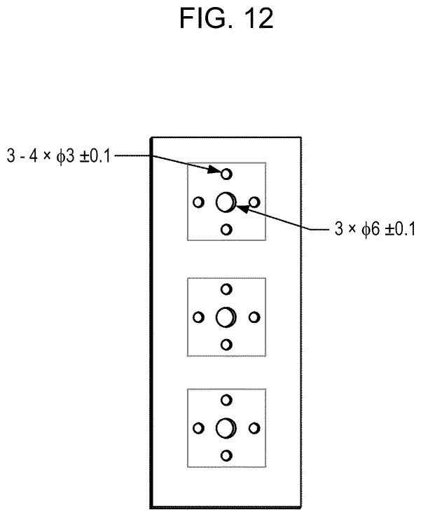

FIG. 12 is a diagram illustrating a case representing that there are three sets of the same dimension group (four holes with a diameter of Φ3 and one hole with a diameter of Φ6), illustrating yet another example description that there are three sets of dimension groups. In FIGS. 12, 3-4×Φ3±0.1 indicates that that there are three sets of four holes with a diameter of Φ3±0.1 as one set, and 3×Φ6±0.1 indicates that there are three sets of holes with a diameter of Φ6±0.1.

Next, specific processing performed by the information processing system 10 according to the exemplary embodiment configured as described above will be described.

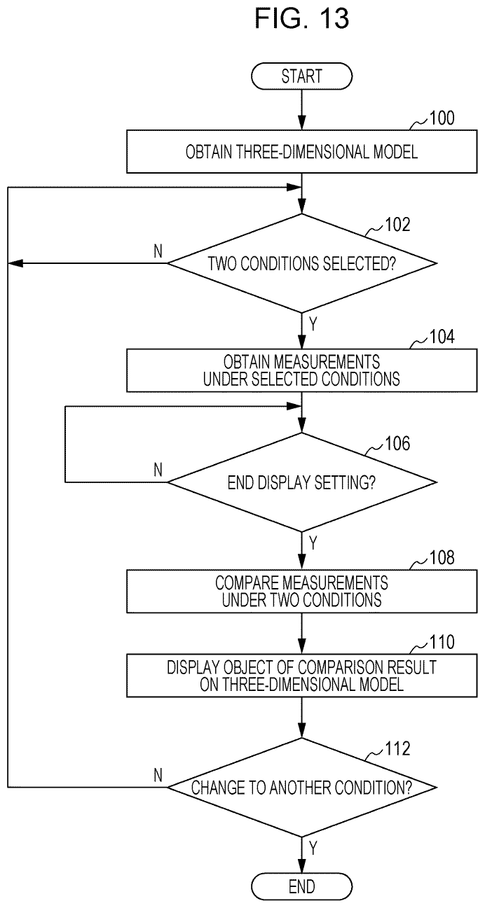

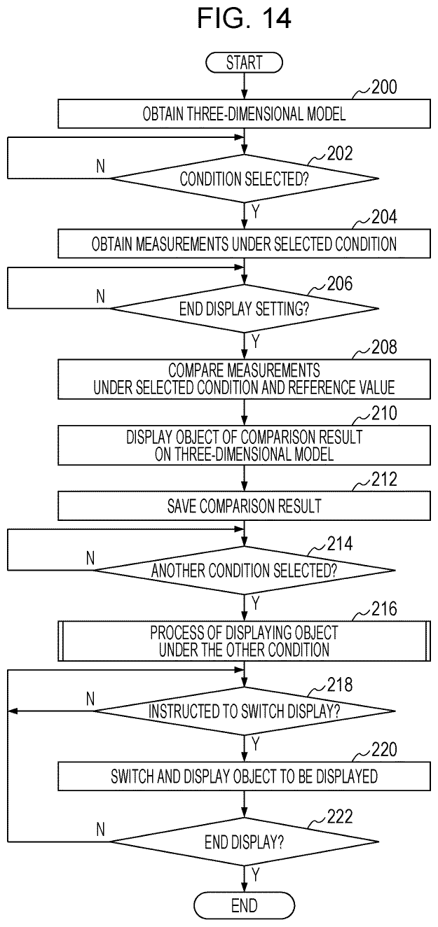

First, the first process of displaying the object 32C representing a comparison result of comparing measurements under different conditions to each other at a corresponding position on the three-dimensional model 30 will be described. FIG. 13 is a flowchart illustrating an example of the flow of the first process performed by the information processing system 10 according to the exemplary embodiment. Note that the process illustrated in FIG. 13 starts, for example, when one client terminal 12 is operated to give an instruction to execute the first process.

In step 100, the CPU 12A obtains the three-dimensional model 30 and transitions to step 102. For example, the CPU 12A obtains a three-dimensional model pre-stored as the DB 24 in the server 14.

In step 102, the CPU 12A determines whether two conditions have been selected. The determination determines whether two conditions have been selected, for example, using the list box 26 illustrated in FIG. 4. The CPU 12A waits until the determination is affirmed, and then transitions to step 104.

In step 104, the CPU 12A obtains measurements under the selected two conditions and transitions to step 106. That is, the obtaining unit 20 obtains measurements of a shaped article manufactured under the selected two conditions. For example, the obtaining unit 20 obtains a first measurement of a shaped article manufactured under a first condition for the three-dimensional model serving as the basis and a second measurement of the shaped article manufactured under a second condition different from the first condition for the three-dimensional model from the DB 24 in the server 14.

In step 106, the CPU 12A determines whether the display setting has ended. The determination determines whether a setting such as whether to use the mean value or worst-case value of each of the measurements has been performed using, for example, the display setting field 28 illustrated in FIG. 4. The CPU 12A waits until the determination is affirmed, and then transitions to step 108.

In step 108, the CPU 12A compares the measurements under the selected two conditions and transitions to step 110. For example, the difference is calculated with reference to, of the mean value or worst-case value of each of the measurements under the two conditions, whichever is better relative to PMI.

In step 110, the CPU 12A displays the comparison result of the measurements under the two conditions on the three-dimensional model, 30 and then transitions to step 112. That is, the display processor 22 performs a process of displaying the third object 32C representing the comparison result of the measurements under the two conditions at a corresponding position on the three-dimensional model 30, as illustrated in FIG. 6.

In step 112, the CPU 12A determines whether to change to another condition. The determination determines, for example, whether an operation to change the condition(s) to be displayed or an operation to give an instruction to change the condition(s) has been performed. If the determination is negative, the process described above returns to step 102 and is repeated, and the series of processes ends when the determination is affirmed.

By performing the process in this way, the object 32C representing the comparison of comparing the first measurement of the shaped article manufactured under the first condition and the second measurement of the shaped article manufactured under the second condition can be displayed at the corresponding position on the three-dimensional model 30. This makes it possible to check changes in quality such as changes over time after mass production, changes or variations between phases of prototyping, etc.

Next, the second process of separately displaying the objects 32A and 32B representing the comparison results of comparing the measurements and the reference value on the three-dimensional model 30 while switching between the objects 32A and 32B on a condition-by-condition basis will be described. Fig, 14 is a flowchart illustrating an example of the flow of the second process performed by the information processing system 10 according to the exemplary embodiment. Note that the process illustrated in FIG. 14 starts, for example, when one client terminal 12 is operated to give an instruction to execute the second process.

In step 200, the CPU 12A obtains the three-dimensional model 30 and transitions to step 202. For example, the CPU 12A obtains a three-dimensional model pre-stored as the DB 24 in the server 14.

In step 202, the CPU 12A determines whether a condition has been selected. The determination determines whether a condition has been selected from, for example, the list box 26 illustrated in FIG. 4. The CPU 12A waits until the determination is affirmed, and then transitions to step 204.

In step 204, the CPU 12A obtains a measurement under the selected condition and transitions to step 206. That is, the obtaining unit 20 obtains a measurement of a shaped article manufactured under the selected condition. For example, the obtaining unit 20 obtains a first measurement of a shaped article manufactured under a first condition for the three-dimensional model 30 serving as the basis from the DB 24 in the server 14.

In step 206, the CPU 12A determines whether the display setting has ended. The determination determines whether a setting such as whether to use the mean value or worst-case value of the measurement has been performed using, for example, the display setting field 28 in FIG. 4. The CPU 12A waits until the determination is affirmed, and then transitions to step 208.

In step 208, the CPU 12A compares the measurement under the selected condition and a reference value, and then transitions to step 210. For example, the difference between the mean value or worst-case value of the measurement and the reference value is calculated.

In step 210, the CPU 12A displays an object representing the comparison result on the three-dimensional model 30, and transitions to step 212. That is, the display processor 22 performs a process of displaying the object 32A or 32B representing the comparison result of comparing the measurement under the selected condition and the reference value at a corresponding position on the three-dimensional model 30, as illustrated in the upper part or lower part of FIG. 5.

In step 212, the CPU 12A saves the comparison result between the measurement under the selected condition and the reference value, and transitions to step 214.

In step 214, the CPU 12A determines whether another condition has been selected. The determination determines whether a condition has been selected from, for example, the list box 26 illustrated in FIG. 4, similar to step 202. The CPU 12A waits until the determination is affirmed, and then transitions to step 216.

In step 216, the CPU 12A performs a process of displaying an object under the selected other condition, and transitions to step 218. The process of displaying the object under the selected other condition displays the object corresponding to the selected other condition on the three-dimensional model by performing the processing in steps 204 to 212 described above for the condition selected in step 214.

In step 218, the CPU 12A determines whether an instruction to switch the display has been given. The determination determines whether an instruction to switch the display has been given by a user operating the operation unit 12E or the like. The CPU 12A waits until the determination is affirmed, and then transitions to step 220. Note that the determination in step 218 may determine whether a predetermined period of time has elapsed, and switch the display between objects under two conditions whenever the predetermined period of time elapses.

In step 220, the CPU 12A switches the object to be displayed to the object corresponding to the saved comparison result, and transitions to step 222.

In step 222, the CPU 12A determines whether to end the display. If the determination is negative, the process described above returns to step 218 and is repeated, and the series of processes ends when the determination is affirmed.

By performing the process in this way, the first object 32A representing the comparison result of comparing the first measurement with a predetermined reference value and the second object 32B representing the comparison result of comparing the second measurement with the predetermined reference value can be separately displayed while being switched. This makes it possible to check changes in the measurement under each condition relative to the reference value.

In the information processing system 10 according to the exemplary embodiment, quality changes such as changes over time after mass production can be immediately checked by the first process and/or the second process, and this can be used as a feedback for the production stage.

In addition, variations between phases can be checked to enable reviewing, such as the reduction of the number of inspections, and this can be used as a feedback for the development stage.

Although the above-described exemplary embodiment describes, as the second process, an example of separately displaying objects (first object and second object) representing comparison results of comparing the measurements under two conditions including the first condition and the second condition and a reference value while switching between the objects, it may be in the form of applying three or more conditions and displaying three or more objects. The second process may also display the third object representing a comparison result of comparing the first measurement and the second measurement, separately being switched from the first object and the second object. That is, the object 32C obtained by the first process may be further switched and displayed as the third object. This makes it possible to check changes in the measurement under each condition relative to the reference value, and also to check changes in the quality due to the changes in the condition.

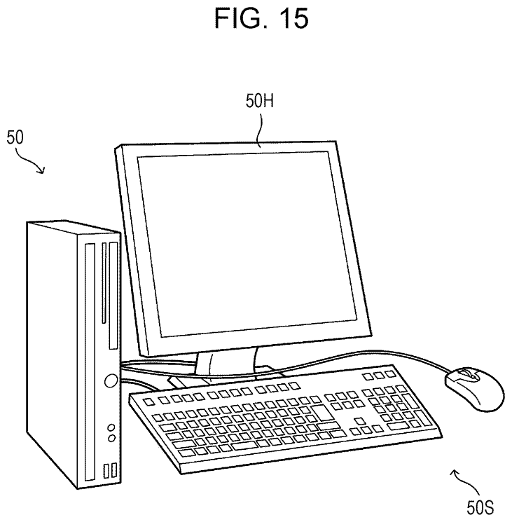

In addition, although the above-described exemplary embodiment describes the information processing system 10 including the client terminals 12 and the server 14, as illustrated in FIG. 15, a single apparatus such as a general-purpose personal computer (PC) 50 with a display 50H and an operation unit 50S such as a keyboard and a mouse may be applied as an information processing system.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

Moreover, although the term “system” in the exemplary embodiment is described as being configured by a plurality of apparatuses as an example, it may be configured by a single apparatus with some of the functions of the plurality of apparatuses.

In addition, the processing performed by the information processing system 10 according to the above-described exemplary embodiment may be processing performed by software, processing performed by hardware, or processing combining both. The processing performed by the information processing system 10 may also be stored as a program in a storage medium and distributed.

Furthermore, the present disclosure is not limited to the above, and, in addition to the above, it goes without saying that the present disclosure can be implemented with various modifications within the scope that does not deviate from the spirit of the disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An information processing system including a processor configured to perform a process comprising:
obtaining a first measurement of a shaped article manufactured under a first condition for a three-dimensional model serving as a basis and a second measurement of the shaped article manufactured under a second condition for the three-dimensional model; and
displaying an object representing a comparison result of comparing the first measurement and the second measurement at a corresponding position on the three-dimensional model of the shaped article.

(((2))) An information processing system including a processor configured to perform a process comprising:
obtaining a first measurement of a shaped article manufactured under a first condition for a three-dimensional model serving as a basis and a second measurement of the shaped article manufactured under a second condition for the three-dimensional model;
separately displaying a first object representing a comparison result of comparing the first measurement with a predetermined reference value and a second object representing a comparison result of comparing the second measurement with the reference value at a corresponding position on the three-dimensional model of the shaped article; and
displaying the first object and the second object while switching between the first object and the second object based on a preset condition.

(((3))) The information processing system according to (((2))), wherein a third object representing a comparison result of comparing the first measurement and the second measurement is displayed, separately being switched from the first object and the second object.

(((4))) The information processing system according to (((3))), wherein the third object represents a comparison result of comparing a mean value or a worst-case value of each of the first measurement and the second measurement.

(((5))) The information processing system according to (((3))) or (((4))), wherein the third object represents a direction and amount of deviation of the first measurement and the second measurement.

(((6))) The information processing system according to (((5))), wherein the third object is an arrow object.

(((7))) The information processing system according to (((1))), wherein the object represents a comparison result of comparing a mean value or a worst-case value of each of the first measurement and the second measurement.

(((8))) The information processing system according to (((2))) or (((3))), wherein the first object represents a comparison result of comparing a mean value or a worst-case value of the first measurement and a predetermined reference value, and the second object represents a comparison result of comparing a mean value or a worst-case value of the second measurement and the reference value.

(((9))) The information processing system according to (((1) or (((7))), wherein the object represents a direction and amount of deviation of the first measurement and the second measurement.

(((10))) The information processing system according to (((9))), wherein the object is an arrow object.

(((11))) The information processing system according to any one of (((2))) to (((6))), or (((8))), wherein the first object represents a direction and amount of deviation of the first measurement from the reference value, and the second object represents a direction and amount of deviation of the second measurement from the reference value.

(((12))) The information processing system according to (((11))), wherein each of the first object and the second object is an arrow object.

(((13))) The information processing system according to (((1))), (((2))), (((9))), or (((10))), wherein the processor is configured to calculate a difference between the first measurement and the second measurement as the comparison result.

(((14))) The information processing system according to (((13))), wherein the difference is calculated using a better determination result relative to a predetermined reference value as a reference.

(((15))) An information processing program causing a computer to execute a process including:
obtaining a first measurement of a shaped article manufactured under a first condition for a three-dimensional model serving as a basis and a second measurement of the shaped article manufactured under a second condition for the three-dimensional model; and
displaying an object representing a comparison result of comparing the first measurement and the second measurement at a corresponding position on the three-dimensional model of the shaped article.

(((16))) An information processing program causing a computer to execute a process including:
obtaining a first measurement of a shaped article manufactured under a first condition for a three-dimensional model serving as a basis and a second measurement of the shaped article manufactured under a second condition for the three-dimensional model;
separately displaying a first object representing a comparison result of comparing the first measurement with a predetermined reference value and a second object representing a comparison result of comparing the second measurement with the reference value at a corresponding position on the three-dimensional model of the shaped article; and
displaying the first object and the second object while switching between the first object and the second object based on a preset condition.

What is claimed is:

1. An information processing system comprising:
a processor configured to perform a process comprising:
obtaining a first measurement of a shaped article manufactured under a first condition for a three-dimensional model serving as a basis and a second measurement of the shaped article manufactured under a second condition for the three-dimensional model; and
displaying an object representing a comparison result of comparing the first measurement and the second measurement at a corresponding position on the three-dimensional model of the shaped article.

2. An information processing system comprising:
a processor configured to perform a process comprising:
obtaining a first measurement of a shaped article manufactured under a first condition for a three-dimensional model serving as a basis and a second measurement of the shaped article manufactured under a second condition for the three-dimensional model;
separately displaying a first object representing a comparison result of comparing the first measurement with a predetermined reference value and a second object representing a comparison result of comparing the second measurement with the reference value at a corresponding position on the three-dimensional model of the shaped article; and
displaying the first object and the second object while switching between the first object and the second object based on a preset condition.

3. The information processing system according to claim 2, wherein a third object representing a comparison result of comparing the first measurement and the second measurement is displayed, separately being switched from the first object and the second object.

4. The information processing system according to claim 3, wherein the third object represents a comparison result of comparing a mean value or a worst-case value of each of the first measurement and the second measurement.

5. The information processing system according to claim 3, wherein the third object represents a direction and amount of deviation of the first measurement and the second measurement.

6. The information processing system according to claim 5, wherein the third object is an arrow object.

7. The information processing system according to claim 1, wherein the object represents a comparison result of comparing a mean value or a worst-case value of each of the first measurement and the second measurement.

8. The information processing system according to claim 2, wherein the first object represents a comparison result of comparing a mean value or a worst-case value of the first measurement and a predetermined reference value, and the second object represents a comparison result of comparing a mean value or a worst-case value of the second measurement and the reference value.

9. The information processing system according to claim 1, wherein the object represents a direction and amount of deviation of the first measurement and the second measurement.

10. The information processing system according to claim 9, wherein the object is an arrow object.

11. The information processing system according to claim 2, wherein the first object represents a direction and amount of deviation of the first measurement from the reference value, and the second object represents a direction and amount of deviation of the second measurement from the reference value.

12. The information processing system according to claim 11, wherein each of the first object and the second object is an arrow object.

13. The information processing system according to claim 1, wherein the processor is configured to calculate a difference between the first measurement and the second measurement as the comparison result.

14. The information processing system according to claim 13, wherein the difference is calculated using a better determination result relative to a predetermined reference value as a reference.

15. A non-transitory computer readable medium storing a program causing a computer to execute a process for information processing, the process comprising:
obtaining a first measurement of a shaped article manufactured under a first condition for a three-dimensional model serving as a basis and a second measurement of the shaped article manufactured under a second condition for the three-dimensional model; and
displaying an object representing a comparison result of comparing the first measurement and the second measurement at a corresponding position on the three-dimensional model of the shaped article.
